(19) United States
(12) Patent Application Publication
(10) Pub. No.: US 2010/0103869 A1
(43) Pub. Date: Apr. 29, 2010

(54) TRANSFERRING DATA IN A MOBILE TELEPHONY NETWORK

(75) Inventor: James Mark Naden, Hertford (GB)

Correspondence Address: BARNES & THORNBURG LLP, P.O. BOX 2786, CHICAGO, IL, 60690-2786, US

(73) Assignee: Nortel Networks Limited, St. Laurent (CA)

(21) Appl. No.: 12/259,484

(22) Filed: Oct. 28, 2008

(51) Int. Cl. H04W 4/00; H04B 7/14

(52) U.S. Cl. 370/328; 455/414.1; 455/7

(57) ABSTRACT

A mobile telephony network comprises base stations operating according to a predetermined standard. A transfer node allows the transfer of data from a first base station to a second base station in the mobile telephone network. Data is sent from the first base station to a data receiver of the data transfer node via a first wireless communications channel complying with the said standard. The received data is transferred via an interface within the transfer node to a data sender of the data transfer node. The data sender sends the transferred data to the second base station via a second wireless communications channel complying with the said standard. The interface within the transfer node does not comply with the operating standard because it transfers data only within the node. Data may be sent from the second base station to the first base station via the node in similar manner. Preferably, the receiver appears to the first base station to be a relay and the sender appears to the second base station to be a user terminal.

### FIELD OF THE INVENTION

The present invention relates to a mobile telephone network, a node for use in the network and to a method of transferring data within the network.

### BACKGROUND OF THE INVENTION

Mobile telephony systems, in which user equipment such as mobile handsets communicate via wireless links to a network of base stations connected to a telecommunications network, have undergone rapid development through a number of generations. The initial deployment of systems using analogue modulation has been superseded by second generation digital systems, which are themselves currently being superseded by third generation digital systems such as UMTS and CDMA. Third generation standards provide for a greater throughput of data than is provided by second generation systems; this trend is continued with the proposal by the Third Generation Partnership Project of the so-called Long Term Evolution system, often simply called LTE, which offers potentially greater capacity still, by the use of wider frequency bands, spectrally efficient modulation techniques and potentially also the exploitation of spatially diverse propagation paths to increase capacity (Multiple In Multiple Out).

Distinct from mobile telephony systems, wireless access systems have also undergone development, initially aimed at providing the “last mile” (or thereabouts) connection between user equipment at a subscriber's premises and the public switched telephone network (PSTN). Such user equipment is typically a terminal to which a telephone or computer is connected, and with early systems there was no provision for mobility or roaming of the user equipment between base stations. However, the WiMax standard (IEEE 802.16) has provided a means for such terminals to connect to the PSTN via high data rate wireless access systems.

Whilst WiMax and LTE have evolved via different routes, both can be characterised as high capacity wireless data systems that serve a similar purpose, typically using similar technology, and in addition both are deployed in a cellular layout as cellular wireless systems. Typically such cellular wireless systems comprise user equipment such as mobile telephony handsets or wireless terminals, a number of base stations, each potentially communicating over what are termed access links with many user equipments located in a coverage area known as a cell, and a two way connection, known as backhaul, between each base station and a telecommunications network such as the PSTN.

As the data capacity of cellular wireless systems increases, this in turn places increasing demands on the capacity of the backhaul, since this is the connection that has to convey the wireless-originating traffic to its destination, often in an entirely different network. For earlier generations of cellular wireless systems, the backhaul has been provided by one or more connections leased from another telecommunications operator (where such a connection exists near to the base station); however, in view of the increasing data rates, the number of leased lines that is required is also increasing. Consequently, the operational expense associated with adopting multiple leased lines has also increased, making this a potentially expensive option for high capacity systems.

As an alternative to leased lines, dedicated backhaul links can be provided by a variety of methods including microwave links or optical fibre links. However each of these methods of backhaul has associated costs. Dedicated fibre links can be expensive in terms of capital expense due mainly to the cost of the civil works in installation, and this problem is especially acute in urban areas. Microwave links also involve the capital expense of equipment and require expert installation due to narrow beam widths leading to the requirement for precise alignment of antennas.

As an alternative to the provision of a dedicated backhaul link for each individual base station, it is possible to use the radio resource of the cellular wireless system to relay backhaul traffic from one base station to another. Typically, the base station using the cellular radio resource for backhaul is a small low power base station with an omnidirectional antenna known as a relay node. Such a system can be used to extend the area of cellular wireless coverage beyond the area of coverage of conventional base stations that are already equipped with a dedicated backhaul.

FIG. 1 shows a conventional wireless cellular network; in this example, base stations 2a . . . 2g are connected by microwave links 4a . . . 4c to a microwave station 6 and thence to a telecommunications network 8.

FIG. 2 shows a conventional relay node operating within a cellular wireless network; the operation may for example be in accordance with IEEE 802.16j. A user equipment 12b is in communication with a relay node 10. As the relay node 10 is not provided with a backhaul link separate from the cellular wireless resource, the relay node is allocated radio resource timeslots for use relaying backhaul data to and from the adjacent base station 2 which is itself connected by microwave link to a microwave station 6 and thence to a telecommunications network 8 such as the public switched telephone network. A user equipment 12a is shown in communication with the base station 2.

It is desirable to increase the capacity of a mobile telephone network. Academic research has indicated that if base stations co-operate instead of operating independently, capacity may be increased. However this requires data to be transferred between base stations. One way of doing that is to use the existing backhaul network of leased lines or dedicated links but that places even more demands on the backhaul network. Another way is to provide dedicated links between base stations but as described above that is expensive.

There is a need to provide for the transfer of data from, and/or between, base stations in a mobile telephony network.

### SUMMARY OF THE INVENTION

In accordance with one aspect of the present invention, there is provided a method of transferring data from a first base station to a second base station in a mobile telephone network operating according to a predetermined standard, the method comprising sending the data from the first base station to a data receiving device via a first wireless communications channel complying with the said standard, transferring the received data to a data sender, and sending the transferred data from the data sender to the second base station via a second wireless communications channel complying with the said standard.

In accordance with a second aspect of the invention, there is provided a data transfer node for use in a mobile telephone network operating according to a predetermined standard, the transfer node comprising a receiver arranged to operate in accordance with the said standard for receiving data from a first base station of the network, a sender arranged to operate in accordance with the said standard for sending data to a second base station of the network, and a data transfer interface coupling the receiver to the sender and arranged to receive data received by the receiver from the first base station and to transfer the said data to the sender for transmission to the second base station.

In accordance with a third aspect of the invention, there is provided a mobile telephone network operating according to a predetermined standard, the network including a first base station, a second base station and a data transfer node according to the second aspect of the invention for transferring data between the first and second base stations.

An embodiment of the invention allows data to be received from the first base station in synchronism with the first base station and in compliance with the operating standard of the network, and sent to the second base station in synchronism with the second base station and in compliance with the operating standard of the network. The data is transferred from the receiver to the sender independently of the operating standard. The sender and the receiver are synchronised with their respective base stations. The transfer of data through the interface may advantageously include retiming of the data so that the receiver and transmitter, being synchronised with their respective base stations, may operate asynchronously with respect to one another. The transferred data may be data allowing the base stations to co-operate so as to improve the capacity of the network. Alternatively, the transferred data may be backhaul data.

In an embodiment of the invention, the receiver and sender communicate with the respective base stations using different parts of the radio resource of the network. An embodiment of the invention allows data to be transferred between base stations using the existing radio resource without needing dedicated additional links such as microwave links or using leased lines in a backhaul network and without the need for additional or dedicated air-interface protocols. The sender and the receiver of the embodiment use the standard protocol of the network. Thus a new protocol is not required and changes to the base stations are not required.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a mobile telephony network;

FIG. 2 is a schematic diagram showing a conventional relay node in communication with a base station;

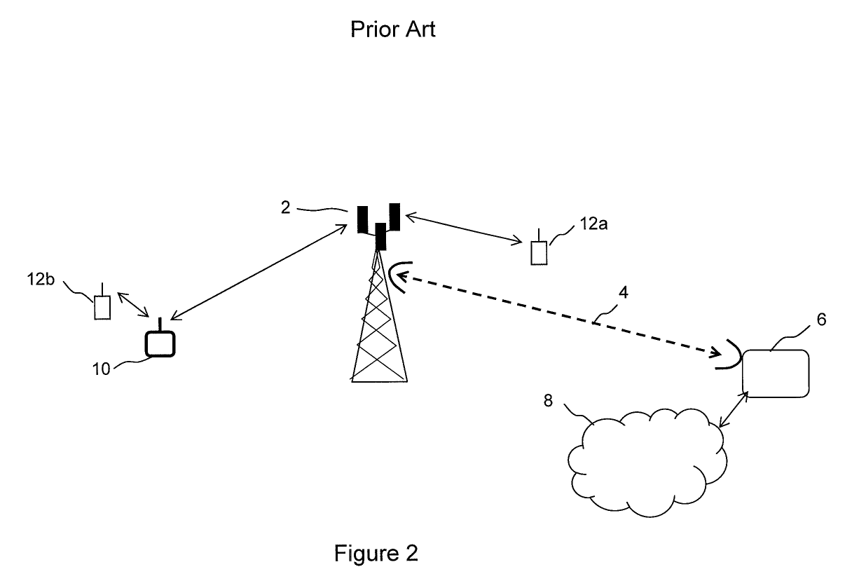

FIG. 3 is a schematic block diagram of a data transfer node in accordance with on embodiment of the invention in communication with two base stations;

FIG. 4 is a schematic block diagram of another embodiment of the data transfer node in accordance with the invention;

FIGS. 5 and 6 are schematic block diagrams of alternative data transfer nodes; and

FIG. 7 is a diagram of a frame structure of an example of a signal complying with IEEE 802.16j.

### DETAILED DESCRIPTION OF THE INVENTION

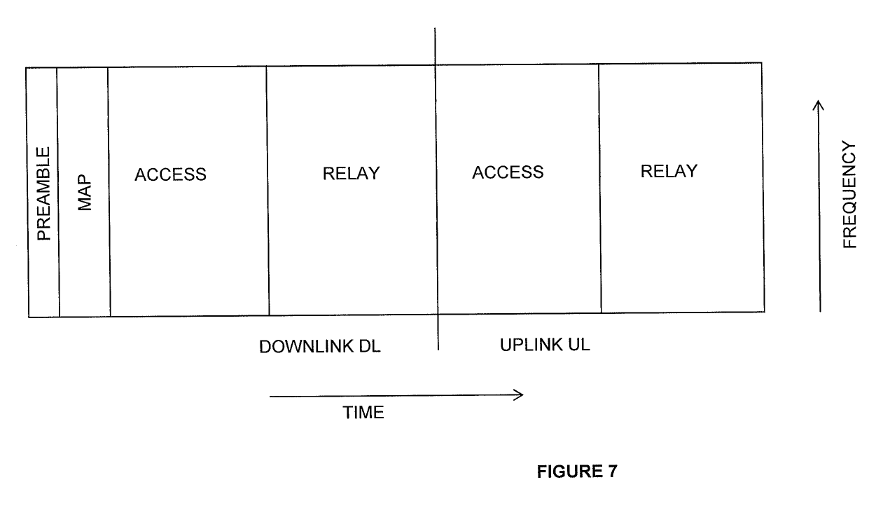

In general, the present invention is directed to methods and apparatus that use the cellular wireless resource within a cellular wireless system. For clarity, the methods and apparatus are described in the context of a high speed packet data system complying with a mobile telephony standard such as IEEE802.16 (WiMax) or LTE, but it will be appreciated that this is by way of example and that the methods and apparatus described are not limited to this example. As is conventional in IEEE802.16, data is transmitted by OFDM in a frame. An example of a frame in the context of the IEEE802.16j standard, which includes the provision of radio resource by the use of relays is shown in FIG. 7. The horizontal axis of the frame represents time and the vertical axis represents frequency. The frame is divided in time into a downlink sub-frame DL in which data is transmitted from a base station to e.g. a user terminal or relay, and an uplink sub-frame UL in which data is transmitted from a user terminal or relay to a base station. The downlink portion may be preceded in time by a preamble and may include a MAP.

The MAP indicates the allocation of the sections of the frame to different users. Sections of the frame allocated to different user terminals and the relay are defined by a combination of time slot (horizontal axis) and frequency (vertical axis) in the frame. The downlink and uplink sub-frames of the frame are divided into a relay zone and an access zone. Data in the relay zone is intended only for the links between relays and base stations and is not received by user terminals. Data in the access zone is received only by user terminal(s) and not by relays. The frame is shown only schematically and other arrangements of frames are possible including non-contiguous zones. The allocation of frequency and time to a relay and to user terminals may be set up across the network in advance.

Firstly, an embodiment of the invention which relates to the exchange of data between base stations for the purpose of enabling co-operation between base stations will be described.

In the following description, references are made for simplicity of description to a “relay” and a “user terminal”. Whilst, as will become apparent, a “relay” may in some embodiments be a device which receives an RF signal and re-transmits it as an RF signal, in others it is a device which receives RF and does not retransmit RF (or receives base band data and transmits it at RF) but complies with the relay requirements of the network's operating standard, for example IEEE802.16j and so appears to its associated base station to be a relay. Likewise a user terminal may be a device having a receiver, a transmitter and a user interface in some embodiments but in others in others it is a device which receives data at base band and transmits it at RF (or receives data at RF and transfers base band data to another device) but complies with the user terminal requirements of the network's operating standard, for example IEEE802.16e and so appears to its associated base station to be a user terminal.

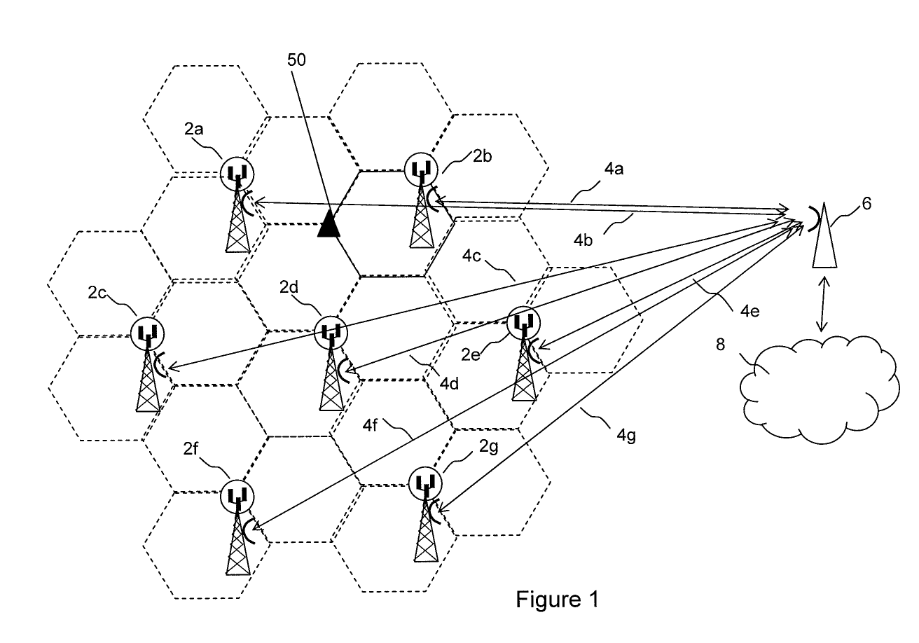

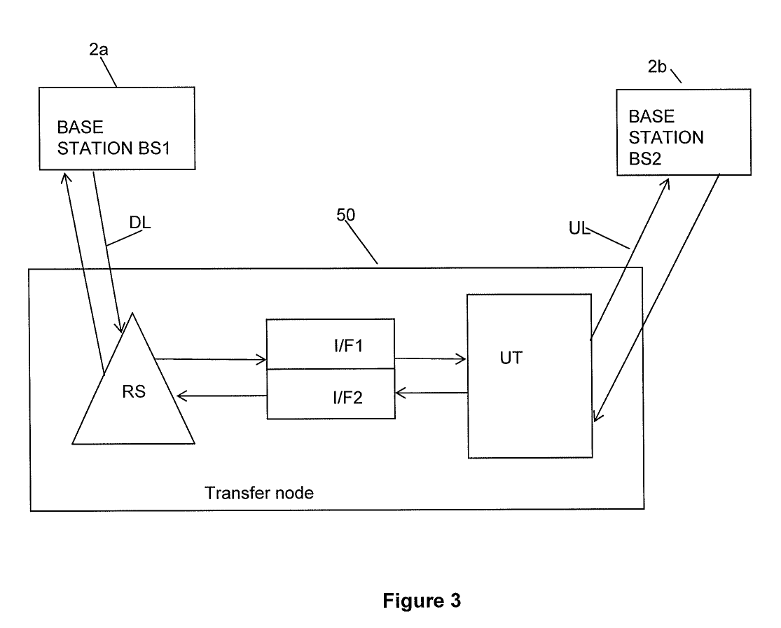

Referring to FIG. 3, base stations BS1, 2a and BS2, 2b of the mobile telephony network of FIG. 1 are linked by a data transfer node 50. The base stations 2a and 2b are conventional base stations operating according to the same operating standard which is the operating standard of the network. The following description considers the transfer of data from base station 2a to base station 2b via the transfer node 50. The transfer node 50 comprises, in this example, a relay RS complying with IEEE802.16j and which receives, from the base station 2a, data in a relay zone of a downlink DL portion of a frame. The transfer node further comprises a user terminal UT complying with IEEE802.16e or IEEE802.16j which sends data to the base station 2b in an access zone of an uplink UL portion of a frame. The relay RS is linked to the user terminal UT by an interface I/F1 which transfers, and may process, data received by the relay to the user terminal. The interface need not comply with the standard because it merely transfers data within the transfer node, does not use any radio resource of the network and does not communicate with any device outside the transfer node. In compliance with conventional operation, the relay RS is synchronised with the base station 2a, that is it is arranged to receive data from the base station during the relay zone of the frame. In accordance with conventional operation, the user terminal UT is synchronised with the base station 2b, that is it is arranged to transmit to the base station 2b during the access zone of the frame. The interface I/F1 receives the data from the relay and provides the data to the user terminal. Additionally, the interface I/F1 may process the data in other ways as will be described herein below.

Data may be transferred from the base station 2b to the base station 2a via the transfer node 50 in which case data is received by the user terminal UT via a downlink from base station 2b, transferred to the relay RS via a further interface I/F2 and sent to the base station 2a by the relay via an uplink.

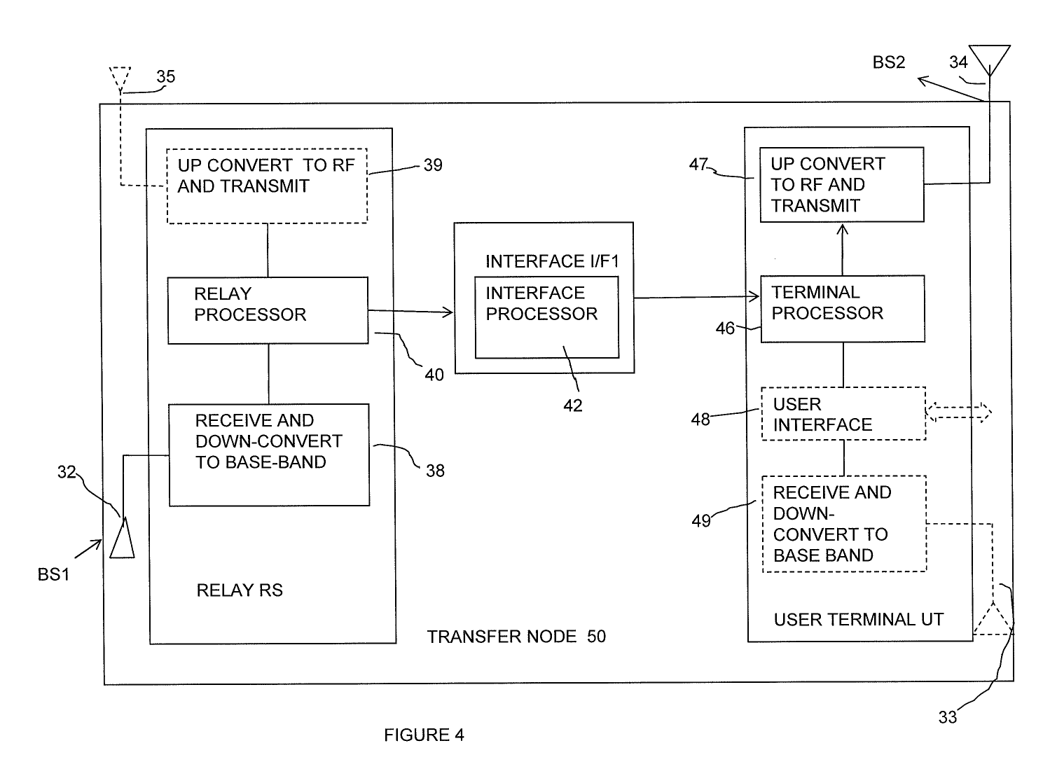

Referring to FIG. 4, an example of a transfer node 50 is shown in more detail, considering only the transfer of data from base station 2a to base station 2b. The transfer node comprises a relay RS complying with the telephony standard, and a user terminal UT complying with the telephony standard. The relay has an antenna 32 and the user terminal has an antenna 34. The relay has a radio receiver 39 including a demodulator which operates in a conventional manner to down convert received RF to base-band and output demodulated digital data. The receiver will typically operate in synchronism with the base station 2a. In this example, the relay has a relay processor 40 which selects from the data received in the relay zone of the frame data to be supplied to the interface I/F1. The interface I/F1 may comprise a processor 42. The transfer node also has the user terminal UT complying with the telephony standard. The user terminal has a processor 46 and a modulator/transmitter 48. The user terminal receives data from the interface and supplies it to the modulator/transmitter 48 for modulation and upconversion in conventional manner. The user terminal will typically operate in synchronism with the base station 2b. The user terminal transmits the data to the base station BS2 (2b) via the antenna 34. The antennas 32 and 34 are shown as separate antennas but it will be apparent to those skilled in the art that the user terminal and relay may share the same physical antenna in some implementations. In one example, the digital data is transferred from the relay RS to the user terminal UT without modification or processing. However, the data may be processed by the processor 42.

The relay may optionally additionally comprise an upconverter and transmitter 39 and an antenna 35 for transmitting data to other relays and/or user terminals and thus may act as a conventional relay for that purpose.

The user terminal may optionally additionally comprise a user interface 48 which may be used for OA&M (operations, administration and maintenance). The user terminal may optionally additionally comprise a receiver 49 including a demodulator which operates in conventional manner to receive RF via an antenna 33 down-convert the RF and output demodulated data to the user interface.

The relay RS receives data from the base station BS1 (2a). In this embodiment of the invention, the relay will select from the data received from the base station BS1:

data intended to be passed on to other user terminals and/or relays if the relay RS comprises the upconverter/transmitter 39; and

other data.

The selection of data to be passed onto other user terminals and/or relays and to the base station BS2 is made using conventional addressing information in the frame; see FIG. 7. Data that is normally transferred on to another node will appear in the traffic channels as user data and thus be distinguished from management and control data. Distinction between these channels is made in the standards for the air interface in question. The relay will detect from the addressing information associated with the data what is the destination node for a specific block of received data: (in IEEE802.16j this is the purpose of the MAP). If the destination node is BS2 then the transfer node will pass it on to BS2. The data transfer node may additionally insert some of the new data it has generated from measurements for example into the packets for BS2, in which case the interface in the transfer node is able to introduce such data into the data stream intended for BS2.

The other data may be data provided by the base station BS1 specifically for use by the other base station BS2 (2b) in which case such data is passed from the relay RS via the interface I/F1 to the user terminal UT unprocessed by the processor in the interface.

The other data may include data which would not be passed on by a conventional relay and/or measurement information of the environment. Data which would not normally be passed on by a conventional relay is for example data that would normally be used internally by the relay, for example to enable efficient operation e.g. effective allocation of resources.

By way of example, the first base station BS1 may collect data from a) the network (typically microwave point to point or wired network connecting base stations to the PSTN); b) measurements it makes itself based on received up-link signals or information contained therein (e.g., provided by user terminals communicating with the base station BS1); and/or c) internal operations in the base station BS1 (e.g., the base station would know what resources its own scheduler was allocating for use in future communications to user terminals). Such data may be precise resource allocations or may be a more general indication of the network characteristics (often referred to as the environment). For example it could be the load on the network (i.e. the proportion of resources in use). In an embodiment of the invention, this data is assembled as a message for the second base station BS2, and it is passed on by the transfer node to the second base station BS2.

Some information may normally be sent by the first base station BS1 intended for a conventional relay itself, to help the relay operate efficiently. Conventionally, such information would not be passed on to any other node in the network. Furthermore, the relay itself may make some measurements similar to a BS in b) and c) above namely, b) from measurements it makes itself based on received up-link signals or information contained therein (e.g., provided by user terminals communicating with the said relay) c) internal operations in the said relay (e.g., the relay would know what resources its own scheduler was allocating for use in future communications to user terminals). This data would not normally be passed on by a conventional relay, as it is normally used for internal purposes to help the relay operate. In an example of the present invention, such information is transferred by the transfer node to the second base station BS2 for the purposes of cooperation, as it increases the knowledge of the radio and network environment in which the base stations BS1 and 2 are operating.

Such other data is fed to the processor 42 of the interface I/F1 which at least reduces the volume of the data and may interpret the data and derive specific metrics which enable the base stations BS1 and BS2 to cooperate. An example of such a metric is an interference map. The processor 42 may extract information relating to the use of radio resources by the received signal or the burst-times of the data or the characteristics of the radio channel or may look for radio resource requests/grants made by the Base Station BS1 to another node which might indicate future use of the radio resources and therefore resources that might not be available for the cooperating base station BS2.

The user terminal UT receives the data from the interface I/F1 in a similar way to user data in a conventional user terminal. The user terminal encodes, modulates and transmits the data to the base station BS2.

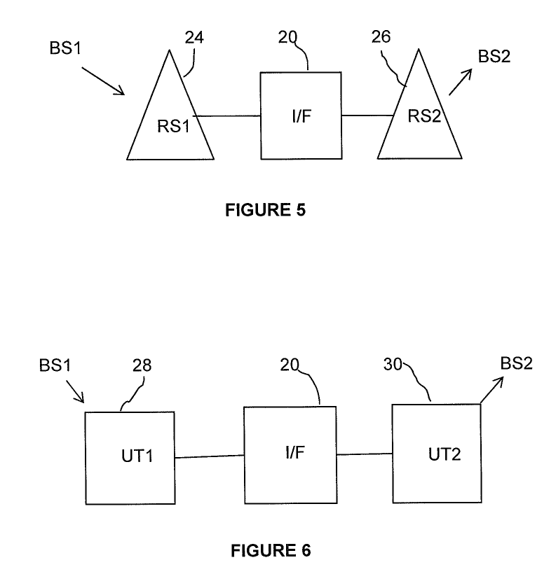

Referring to FIG. 5 the transfer node 50 may comprise a first relay 24 complying with the mobile telephony standard communicating with base station 2a coupled by an interface I/F to a second relay complying with the mobile telephony standard communicating with base station 2b. Referring to FIG. 6 the transfer node 50 may comprise a first user terminal 28 complying with the mobile telephony standard communicating with base station 2a coupled by an interface I/F to a second user terminal 30 complying with the mobile telephony standard communicating with base station 2b. The transfer nodes of FIGS. 5 and 6 operate in similar manner to the transfer node of FIG. 4.

As described above the transfer node may be implemented such that it appears as: A) a user terminal to both of the cooperating base stations BS1 and 2; or B) as a relay node to one of the cooperating base stations and as a user terminal to the other base station; or C) as a relay node to both of the cooperating base stations.

A) Referring to FIG. 6, in the case that the transfer node appears as having two user terminals UT1 and UT2, base station BS1 allocates downlink resources for transmission to user terminal UT1 of the transfer node and transmits to the transfer node using these resources. The transfer node also has a user terminal UT2 to transmit to base station BS2. Internally, the transfer node passes information from user terminal UT1 to user terminal UT2. No air-interface resources are required for this purpose, as this communication occurs totally internally to the transfer node and is not apparent to other nodes in the network. The user terminal UT2 requests uplink resources from BS2 for the purpose of transmitting information derived from the signal received from BS1 to BS2. The transfer node has a dual personality, represented by user terminals UT1 and UT2, which is utilised for communication with the respective base stations, BS1 and BS2. User terminal UT1 is associated with and synchronised with base station BS1, while user terminal UT2 is associated with and synchronised with base station BS2.

B) Referring to FIG. 4, in the case that the transfer node has a relay node RS and a user terminal UT, the base station BS1 allocates downlink resources for transmission to the relay RS1 and transmits to the transfer node using these resources. The transfer node appears as a user terminal UT to base station BS2. Internally, the transfer node passes information from relay RS to user terminal UT. No air-interface resources are required for this purpose, as this communication occurs totally internally to the transfer node and is not apparent to other nodes in the network. The user terminal UT requests uplink resources for the purpose of transmitting information derived from the signal received from base station BS1 to base station BS2. The transfer node has a dual personality, represented by the relay RS and the user terminal UT, which is utilised for communication with the respective base stations, BS1 and BS2. The relay RS is associated with and synchronised with BS1, while the user terminal UT is associated with and synchronised with BS2.

C) Referring to FIG. 5, in the case that the transfer node has two relay nodes RS1 and RS2 the base station BS1 allocates downlink resources for transmission to the relay RS1 and transmits to the transfer node using these resources. The transfer node appears as a relay RS2 to base station BS2. Internally, the transfer node passes information from the relay RS1 to relay RS2. No air-interface resources are required for this purpose, as this communication occurs totally internally to the transfer node and is not apparent to other nodes in the network. The relay node RS2 requests uplink resources from base station BS2 for the purpose of transmitting information derived from the signal received from base station BS1 to base station BS2. The transfer node has a dual personality, represented by relay nodes RS1 and RS2, which is utilised for communication with the respective base stations, BS1 and BS2. Relay node RS1 is associated with, and synchronised with, base station BS1, while relay node RS2 is associated with and synchronised with base station BS2.

For the case of centralised scheduling, scheduling decisions may be made independently by each base station and there may be no coordination of resource allocation between base stations BS1 and BS2. Consequently, in case A) (FIG. 6), the resources allocated by base station BS2 for uplink communication between user terminal UT2 and base station BS2 may be the same as those allocated by base station BS1 for uplink communication between user terminal UT 1 and base station BS1, resulting in a conflict in which the transfer node is required to transmit two different sets of data to the two base stations using the same resources. (Uplink communication between user terminal UT1 and BS1 may be the result of the exchange of control data to maintain the link or may be due to the need for communication by the transfer node of information derived from a downlink signal from base station BS₂.) A similar conflict can occur where the transfer node appears as a relay node to both base stations as in case C) (FIG. 5).

If, however, the transfer node appears as a relay node RS to one of the Base Station and as a user terminal to the other base station as in Case B) (FIG. 4), communication between the relay node and the one Base Station and will occur in the “relay zone” and be orthogonal to the “access zone” used for communication between the other base station and the user terminal UT. Hence there will be no conflict in the form of a requirement for simultaneous use of identical resources for uplink communication with the two base stations or indeed for downlink communication from the base station to the transfer node.

For the case of distributed scheduling, scheduling decisions are made independently by each node, including the transfer node, which may coordinate resource allocation for uplink communication between the transfer node and the two base stations, BS1 and BS2. Nevertheless, downlink communications from the two base stations may occur using the same resources.

Consequently, while a transfer node may appear as two user terminals, or as two relays, our currently preferred embodiment is one in which the transfer node appears as a relay node to one of the cooperating base stations and as a user terminal to the other. The receiver and sender use different parts of the radio resource. In the present example, as shown in FIG. 7, the receiver and sender uses different zones of a frame to communicate with their associated base stations.

The example of the transfer node described above provides a mechanism for two base stations to communicate which could not otherwise communicate effectively and efficiently. Base stations are not designed to communicate directly with one another, for a number of very good reasons. For example, antennas of base stations are typically not aligned with one another, as to do so would result in unduly high levels of interference in the normal operation of communicating with user terminals.

The transfer node allows cooperation between base stations in order to enhance the performance (e.g. increase capacity, reduce latency) of the cellular wireless network of which they are components. To this end, information is exchanged between cooperating base stations via the transfer node so that each base station has better information relating to the network environment in which it operates.

Such information may for example contain a preferred allocation of resources for communication with its associated user terminals by one of the base stations. Knowing which resources are in use by the first base station BS1, the cooperating second base station BS2 may then allocate alternative resources for communication with its own associated user terminals, thus minimising mutual interference. In some cases it may be that the same resource can be used by both base stations if the respective user terminals are shielded by the environment from interference from the other base station. Such an interference map may be assembled over time based on exchange of information between the base stations via the transfer node. So-called “soft frequency reuse” may also be enabled by such measures, where both base stations are enabled to use the same resource but at lower power, thus minimising interference. This type of information is relatively compact and does not require much in the way of resources to communicate it between the base stations.

At a more advanced level, part of the actual data being transmitted to the first base station BS1 may be passed to the second base station BS2, which may then use this in its receiver to better demodulate and decode signals from its own associated user terminals. The signals received by the second base station BS2 would be a mixture of wanted signal from a user terminal and interference associated with terminals communicating with the first base station BS1.

By knowing the data for the first base station, which constitutes interference, its effects can be reduced or removed entirely. This requires a greater exchange of information between the base stations via the transfer node and it is for the system designer to decide on the appropriate trade-off between the amount of resources required to exchange cooperation data and the benefit obtained in terms of improved throughput to user terminals.

The transfer node 50 may be positioned at the boundary of the cells served by the two base stations as shown in FIG. 1.

The above embodiments are to be understood as illustrative examples of the invention. Further embodiments of the invention are envisaged.

The invention is not limited to WiMAX or LTE and may be applied in the context of another mobile telephony standard, for example those being developed under the IMT advanced standards.

A transfer node 50 may be associated with more than two base stations. For example, a transfer node may be associated with three cells. As shown in FIG. 1 the transfer node may be positioned at the intersection of three adjacent cells served by base stations 2a, 2b and 2d. Multiple zones of a frame are allowed in for example WiMAX. It would be necessary to include an extra relay node in the transfer node. The first relay node associates with the base station BS1 and the user terminal UT associates with base station BS2. A second relay node would associate with another base station BS3 and the interface I/F1 would be required to interface between all three of the first and second relays and the user terminal. Thus, it will be apparent to those skilled in the art that the concept of the invention extends to enabling cooperation between more than two base stations by introducing for example additional relays into the transfer node, each relay node and user terminal of the transfer node relying on a separate zone of a frame. Instead of introducing additional relays, other types of node could be used as described with reference to FIGS. 5 and 6 for example Furthermore, reverse paths from BS2 to BS1, from BS2 to BS3 and from BS1 to BS3 may be provided. An example of forward and reverse paths is shown in FIG. 3.

The invention has been described by way of example with reference to transferring data between base stations to allow them to co-operate. However, the transfer node could be used to transfer any data between base stations. For example, backhaul data could be transferred from one base station which is not connected to a backhaul network to another base station which is connected to a backhaul network.

The data may be transferred between the receiver and sender in undemodulated and undecoded form, for example as radio frequency (RF) or intermediate frequency (IF) signals, or as baseband signals at a zero or near-zero intermediate frequency. The signals may be transferred in sampled form, which may be Nyquist sampled, oversampled or under sampled. For example, the signals may be transferred as sampled received signal vectors, each vector representing a modulation symbol; the benefit of this is that data processing is reduced between reception and retransmission. Alternatively, data may be demodulated and/or decoded following reception and then re-encoded and remodulated for transmission. The advantage is that the data can be accessed to make use of the content and potentially to compress the data by removal of components that do not require retransmission. In addition, reception, demodulation and re-modulation may remove interference from the signal before re-transmission. Similarly, decoding and recoding can exploit error correction coding to reduce errors in the re-transmitted signal, thereby improving the reliability of the data transfer between the base stations. As discussed above the transfer node selects data to be transferred from the receiver to the sender. Various options are available. The data which is transferred from the relay to the user terminal may be:

1) All the data received in the relay zone;

2) A selection of the data received in the relay zone; and

3) A description of the data.

The data selector may be able, under suitable control, to select 1) or 2).

As described above with reference to FIG. 4, the relay has a processor 40 which selects data to be transferred to the sender. However, the processor 42 of the interface may select data to be transferred to the sender.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of transferring data from a first base station to a second base station in a mobile telephone network operating according to a predetermined standard, the method comprising
sending the data from the first base station to a data receiver of a data transfer node via a first wireless communications channel complying with the said standard,
transferring the received data to a data sender of the data transfer node, and
sending the transferred data from the data sender to the second base station via a second wireless communications channel complying with the said standard.

2. A method according to claim 1, wherein the data receiver is synchronised with the first base station, the data sender is synchronised with the second base station, and transferring the data from the receiver to the sender synchronises the data with the sender.

3. A method according to claim 1, wherein the data transferred by the transfer node between the sender and the receiver allows cooperation between the first and second base stations.

4. A method according to claim 3, wherein the said transferred data is network management information.

5. A method according to claim 3, wherein the second base station uses the transferred data to improve the spectral efficiency of the network.

6. A method according to claim 3, wherein the data transfer node selects and extracts the said data from other data received by the receiver and transfers it to the sender.

7. A method according to claim 3, wherein the transfer node comprises a processor between the receiver and the sender and the processor processes data received by the receiver to produce the data which is transferred to the sender.

8. A method according to claim 1, wherein the receiver is a device which, in operation, appears to the first base station to be a relay and the sender is a device which, in operation, appears to the second base station to be a user terminal.

9. A method according to claim 1, wherein the receiver is a device which, in operation, appears to the first base station to be a user terminal and the sender is a device which, in operation, appears to the second base station to be a relay.

10. A method according to claim 1, wherein the receiver is a device which, in operation, appears to the first base station to be a relay and the sender is a device which, in operation, appears to the second base station to be a relay.

11. A method according to claim 1, wherein the receiver is a device which, in operation, appears to the first base station to be a user terminal and the sender is a device which, in operation, appears to the second base station to be a user terminal.

12. A method according to claim 8, wherein the said device, which in operation appears to be a relay, complies with IEEE802.16j.

13. A method according to claim 8, wherein the said device, which in 30 operation appears to be a user terminal, complies with IEEE802.16e.

14. A method according to claim 1, further comprising sending data from the second base station to a further data receiver device via a third communications channel complying with the said standard,
transferring the received data to a further data sender, and
sending the transferred data to the first base station via a fourth communications channel complying with the said standard, whereby data is transferred from the second base station to the first base station.

15. A method according to claim 1, wherein the second base station is connected to a backhaul network and the transferred data is backhaul data.

16. A data transfer node for use in a mobile telephone network operation according to a predetermined standard, the transfer node comprising a wireless receiver arranged to operate in accordance with the said standard for receiving data from a first base station of the network, a wireless sender arranged to operate in accordance with the said standard for sending data to a second base station of the network, and a data transfer interface connected to the receiver and the sender and arranged to receive data received by the receiver from the first base station and to transfer the said data to the sender for transmission to the second base station.

17. A data transfer node according to claim 16, wherein the receiver is operable in synchronism with the operation of the first base station, the interface is arranged to transfer the data received from the receiver to the sender, and the sender is operable in synchronism with the second base station.

18. A data transfer node according to claim 16, comprising a data selector operable to select, from data received by the receiver, the data to be transferred to the sender.

19. A data transfer node according to claim 16, wherein the transfer node comprises a processor between the receiver and the sender, the processor being operable to process data received by the receiver to produce the data which is transferred to the sender.

20. A data transfer node according to claim 16, wherein the receiver is a device which, in operation, appears to the first base station to be a relay and the sender is a device which, in operation, appears to the second base station to be a user terminal.

21. A data transfer node according to claim 16, wherein the receiver is a device which, in operation, appears to the first base station to be a user terminal and the sender is a device which, in operation, appears to the second base station to be a relay.

22. A data transfer node according to claim 16, wherein the receiver is a device which, in operation, appears to the first base station to be a relay and the sender is a device which, in operation, appears to the second base station to be a relay.

23. A data transfer node according to claims 16, wherein the receiver is a device which, in operation, appears to the first base station to be a user terminal and the sender is a device which, in operation, appears to the second base station to be a user terminal.

24. A data transfer node according to claim 20, wherein the said device, which in operation appears to be a relay, complies with IEEE802.16j.

25. A data transfer node according to claim 20, wherein the said device, which in operation appears to be a user terminal, complies with IEEE802.16e.

26. A data transfer node according to claim 16, further comprising a further receiver arranged to operate in accordance with the said standard for receiving data from the second base station of the network, a further sender arranged to operate in accordance with the said standard for sending data to the first base station of the network, and a further data transfer interface connected to the further receiver and the further sender and arranged to receive data received by the further receiver from the second base station and to transfer the said data to the further sender for transmission to the first base station.

27. A mobile telephone network operating according to a predetermined standard, the network including a first base station, a second base station and a data transfer node according to claim 16 arranged to transfer data from the first base station to the second base station.

28. A network according to claim 27, wherein the data transfer node is located at the boundary of two cells served by the respective base stations.
